(19) United States
(12) Patent Application Publication
(10) Pub. No.: US 2013/0137479 A1
(43) Pub. Date: May 30, 2013

(54) MOBILE TERMINAL AND METHOD FOR UPDATING PHONE BOOK THEREOF

(71) Applicants: Seungcheon Baek, Seoul (KR); Seungwon Lee, Seoul (KR); Jinwook Choi, Seoul (KR); Jungsu Lee, Seoul (KR)

(72) Inventors: Seungcheon Baek, Seoul (KR); Seungwon Lee, Seoul (KR); Jinwook Choi, Seoul (KR); Jungsu Lee, Seoul (KR)

(73) Assignee: LG ELECTRONICS INC., Seoul (KR)

(21) Appl. No.: 13/062,226

(22) PCT Filed: Aug. 19, 2010
(86) PCT No.: PCT/KR2010/005478

§ 371 Date: Mar. 4, 2011

(51) Int. Cl. H04M 1/57

(52) U.S. Cl. CPC H04M 1/575
USPC 455/550.1

(57) ABSTRACT

Disclosed are a mobile terminal capable of updating an existing phone number of a counterpart stored in a phone book to a new phone number by using situation information collected during call communication with the counterpart whose phone number has been changed, and a method for updating a phone book of a mobile terminal. The mobile terminal includes: a communication unit configured to obtain a first phone number and supplementary information corresponding to the first phone number when a call connection is requested or a call connection request is received; and a controller configured to select a second phone number stored in a phone book based on the supplementary information and change the selected second phone number into the first phone number or recommend changing of the selected second phone number into the first phone number.

### TECHNICAL FIELD

The present invention relates to a mobile terminal and a method for updating a phone book of a mobile terminal and, more particularly, to a mobile terminal capable of updating phone numbers stored in a phone book and a method for updating a phone book of a mobile terminal.

### BACKGROUND ART

Recently, as mobile terminals provide various, complex functions, a consideration of the convenience of user interfaces (UIs) including a phone book, and the like, is required.

### TECHNICAL GIST OF THE PRESENT INVENTION

Therefore, it is an object of the present invention to provide a mobile terminal capable of updating an existing phone number of a counterpart stored in a phone book to a new phone number by using context information collected during communication with the counterpart whose phone number has been changed, and a method for updating a phone book of a mobile terminal.

In order to achieve the above object, there is provided a mobile terminal including: a communication unit configured to obtain a first phone number and supplementary information corresponding to the first phone number when a call connection is requested or a call connection request is received; and a controller configured to select a second phone number stored in a phone book based on the supplementary information, and change the selected second phone number into the first phone number or recommend changing of the selected second phone number into the first phone number.

The call connection may be a communication call connection or a message call connection. The message call connection may be a message call connection according to a text message service, an instant message service, or an e-mail service. The text message service may be a short message service (SMS), a multimedia messaging service (MMS), or an enhanced message service (EMS).

The supplementary information corresponding to the first phone number may be obtained from a message or a conversation transmitted or received according to the call connection. The supplementary information corresponding to the first phone number may include at least one of a name, an address, an e-mail address, a homepage address, an image, and a birthday. The supplementary information corresponding to the first phone number may include a voice pattern. The supplementary information corresponding to the first phone number may be obtained by using speech-to-text.

The controller may change the selected second phone number into the first phone number or recommend changing of the selected second phone number into the first phone number, before, during, or after a communication session according to the call connection.

In order to achieve the above object, there is also provided a method for updating a phone book of a mobile terminal, including: when a call connection is requested or when a call connection request is received, obtaining a first phone number and supplementary information corresponding to the first phone number; selecting a second phone number stored in a phone book based on the supplementary information; and changing the selected second phone number into the first phone number or recommending changing of the selected second phone number into the first phone number.

In order to achieve the above object, there is also provided a mobile terminal including: a communication unit configured to obtain a first phone number when a call connection is requested or a call connection request is received; and a controller configured to select a second phone number stored in a phone book based on the first phone number, and change the selected second phone number into the first phone number or recommend changing of the selected second phone number into the first phone number.

The call connection may be a communication call connection or a message call connection. The first phone number may be obtained from a message or a conversation transmitted or received according to the call connection. The first phone number may be obtained by using speech-to-text.

The controller may change the selected second phone number into the first phone number or recommend changing of the selected second phone number into the first phone number, before, during, or after a communication session according to the call connection.

### BRIEF DESCRIPTION OF THE DRAWINGS

FIG. 1 is a conceptual view showing the process of updating a phone book according to an exemplary embodiment of the present invention;

FIG. 2 is a schematic block diagram of a mobile terminal according to an exemplary embodiment of the present invention;

FIG. 3 is a flow chart illustrating the process of updating a phone book according to an exemplary embodiment of the present invention;

FIG. 4 is an overview of a display screen illustrating a phone book stored in a phone book and supplementary information according to an exemplary embodiment of the present invention;

FIG. 5 is an overview of a display screen illustrating the process of updating a phone book according to a first exemplary embodiment of the present invention;

FIGS. 6 and 7 are overviews of display screens illustrating the process of updating a phone book according to a second exemplary embodiment of the present invention;

FIG. 8 is a flow chart illustrating the process of updating a phone book according to another exemplary embodiment of the present invention;

FIG. 9 is an overview of a display screen illustrating the process of updating a phone book according to a third exemplary embodiment of the present invention;

FIG. 10 is an overview of a display screen illustrating the process of updating a phone book according to a fourth exemplary embodiment of the present invention; and

FIG. 11 is an overview of a display screen illustrating the process of updating a phone book according to a fifth exemplary embodiment of the present invention.

### MODE FOR CARRYING OUT THE PREFERRED EMBODIMENTS

The mobile terminal according to exemplary embodiments of the present invention will now be described with reference to the accompanying drawings. In the following description, usage of suffixes such as ‘module’, ‘part’ or ‘unit’ used for referring to elements is given merely to facilitate explanation of the present invention, without having any significant meaning by itself.

As the technology development is getting speeded up, the period of changing a mobile terminal by users is shortened. When users are changing their mobile terminal, they increasingly tend to change phone numbers according to the policy of communication network providers or according to personal reasons. Also, as a phone book function for managing contact numbers of acquaintances provided in mobile terminals is becoming intelligent, users tend to choose to rely on the phone book function, rather than memorizing phone numbers one by one, so the users' convenience is dependent upon the phone book function of mobile terminals. Thus, when a user changes his phone number, information regarding the changed phone number is to be necessarily provided to acquaintances through a text message, a call, or the like, to eliminate inconvenience in using the phone book function.

However, the procedure of notifying about the changed phone number or storing the same is much troublesome at the counterpart side who must notify acquaintances about the changed phone number and at the user side who must store the changed phone number in a phone book. Thus, a function that may be able to omit the procedure of notifying about the changed phone number or conveniently store at least the changed phone number is required.

### Updating Phone Book

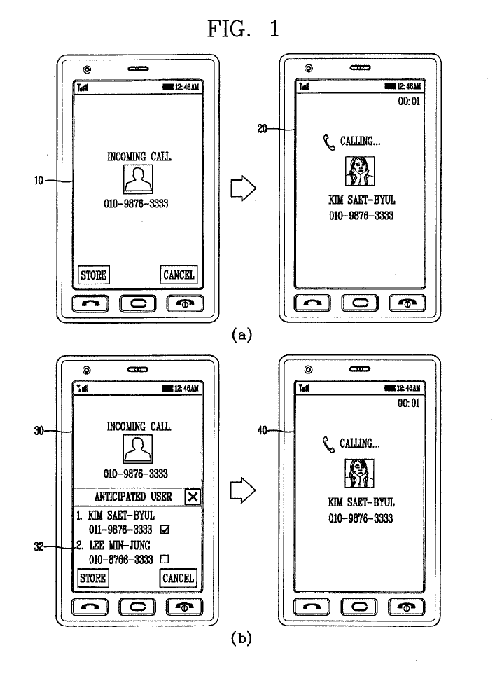

FIG. 1 is a conceptual view showing the process of updating a phone book according to an exemplary embodiment of the present invention.

With reference to FIG. 1(a), when a call connection request is received by a mobile terminal, a call request screen image 10 is displayed. The call request screen image 10 is displayed to include information regarding a counterpart who has requested a call connection, and in particular, when a phone number of the counterpart is a phone number stored in the phone book of the mobile terminal, supplementary information corresponding to the phone number of the counterpart, such as the name of the counterpart, and the like, may be displayed together. In this case, the user may easily recognize the counterpart based on the displayed supplementary information. However, when the phone number has been changed, the supplementary information corresponding to the changed phone number of the counterpart cannot be searched from the phone book, so the supplementary information cannot be displayed together and the user cannot recognize the counterpart.

The mobile terminal according to an exemplary embodiment of the present invention may obtain supplementary information corresponding to the changed phone number of the counterpart, such as the name of the counterpart, or the like, from content of conversation with the counterpart and select a phone number presumed to be the old phone number (namely, the phone number before it was changed) of the counterpart from the phone book. Also, the mobile terminal may change the selected phone number into a new phone number (namely, the changed phone number) and display additionally the supplementary information corresponding to the changed phone number on the screen 20 in the course of conversation according to the changed phone number. Thus, the user can easily recognize the counterpart based on the displayed supplementary information, and there is no further need to store the changed phone number of the counterpart.

With reference to FIG. 1(b), when a call connection request is received by the mobile terminal, a call request screen image 30 is displayed. The call request screen image 30 is displayed with information regarding the counterpart which has requested the call, and when the phone number of the counterpart has been changed, the supplementary information corresponding to the changed phone number of the counterpart cannot be searched from the phone book, so the supplementary information cannot be displayed together.

The mobile terminal according to an exemplary embodiment of the present invention may obtain supplementary information corresponding to the changed phone number of the counterpart, such as the name of the counterpart, or the like, from content of conversation with the counterpart and select a phone number presumed to be the old phone number (namely, the phone number before it was changed) of the counterpart from the phone book. In this case, when a plurality of phone numbers are selected, the mobile terminal may provide information 32 regarding the plurality of phone numbers, and change one or more phone numbers selected by the user from among the plurality of provided phone numbers into changed phone numbers. When one phone number is selected, as shown in FIG. 1(a), the mobile terminal may provide information regarding the selected phone number to the user, rather than directly changing the selected phone number into a changed phone number, and change the selected phone number into the changed phone number according to a user instruction. The mobile terminal may also display the supplementary information corresponding to the changed phone number on a screen 40 in the course of conversation according to the changed phone number.

Thus, the counterpart whose phone number has been changed according to a change in subscription, or the like, may not need to further inform an acquaintance about the changed phone number, and the user of the mobile terminal may conveniently store the changed phone number of the counterpart.

### Mobile Terminal

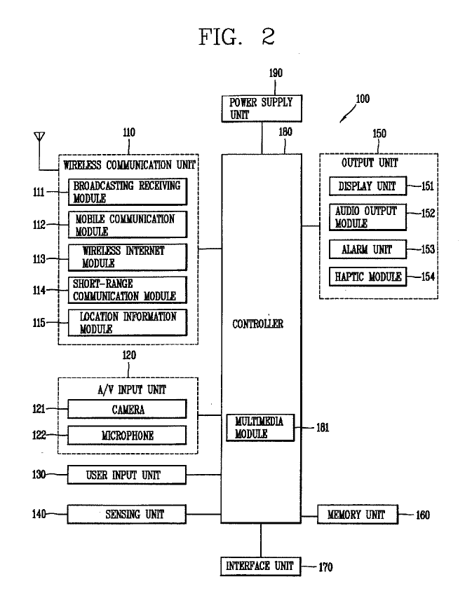

FIG. 2 is a block diagram of a mobile terminal according to an embodiment of the present invention.

The mobile terminal 100 may include a wireless communication unit 110, an AN (Audio/Video) input unit 120, a user input unit 130, a sensing unit 140, an output unit 150, a memory 160, an interface unit 170, a controller 180, and a power supply unit 190, etc. FIG. 2 shows the mobile terminal as having various components, but it should be understood that implementing all of the illustrated components is not a requirement. Greater or fewer components may alternatively be implemented. The elements of the mobile terminal will be described in detail as follows.

The wireless communication unit 110 typically includes one or more components allowing radio communication between the mobile terminal 100 and a wireless communication system or a network in which the mobile terminal is located. For example, the wireless communication unit may include at least one of a broadcast receiving module 111, a mobile communication module 112, a wireless Internet module 113, a short-range communication module 114, and a location information module 115.

The broadcast receiving module 111 receives broadcast signals and/or broadcast associated information from an external broadcast management server (or other network entity) via a broadcast channel.

The broadcast channel may include a satellite channel and/or a terrestrial channel. The broadcast management server may be a server that generates and transmits a broadcast signal and/or broadcast associated information or a server that receives a previously generated broadcast signal and/or broadcast associated information and transmits the same to a terminal. The broadcast signal may include a TV broadcast signal, a radio broadcast signal, a data broadcast signal, and the like. Also, the broadcast signal may further include a broadcast signal combined with a TV or radio broadcast signal.

The broadcast associated information may refer to information associated with a broadcast channel, a broadcast program or a broadcast service provider. The broadcast associated information may also be provided via a mobile communication network and, in this case, the broadcast associated information may be received by the mobile communication module 112. The broadcast signal may exist in various forms. For example, it may exist in the form of an electronic program guide (EPG) of digital multimedia broadcasting (DMB), electronic service guide (ESG) of digital video broadcast-handheld (DVB-H), and the like.

The broadcast receiving module 111 may be configured to receive signals broadcast by using various types of broadcast systems. In particular, the broadcast receiving module 111 may receive a digital broadcast by using a digital broadcast system such as multimedia broadcasting-terrestrial (DMB-T), digital multimedia broadcasting-satellite (DMB-S), digital video broadcast-handheld (DVB-H), the data broadcasting system known as media forward link only (MediaFLO®), integrated services digital broadcast-terrestrial (ISDB-T), etc. The broadcast receiving module 111 may be configured to be suitable for every broadcast system that provides a broadcast signal as well as the above-mentioned digital broadcast systems.

Broadcast signals and/or broadcast-associated information received via the broadcast receiving module 111 may be stored in the memory 160 (or anther type of storage medium).

The mobile communication module 112 transmits and/or receives radio signals to and/or from at least one of a base station (e.g., access point, Node B, etc.), an external terminal (e.g., other user devices) and a server (or other network entities). Such radio signals may include a voice call signal, a video call signal or various types of data according to text and/or multimedia message transmission and/or reception.

The wireless Internet module 113 supports wireless Internet access for the mobile terminal. This module may be internally or externally coupled to the terminal. The wireless Internet access technique implemented may include a WLAN (Wireless LAN) (Wi-Fi), Wibro (Wireless broadband), Wimax (World Interoperability for Microwave Access), HSDPA (High Speed Downlink Packet Access), or the like.

The short-range communication module 114 is a module for supporting short range communications. Some examples of short-range communication technology include Bluetooth™, Radio Frequency IDentification (RFID), Infrared Data Association (IrDA), Ultra-WideBand (UWB), ZigBee™, and the like.

The location information module 115 is a module for checking or acquiring a location (or position) of the mobile terminal. A typical example of the location information module is a GPS (Global Positioning System).

With reference to FIG. 2, the A/V input unit 120 is configured to receive an audio or video signal. The A/V input unit 120 may include a camera 121 (or other image capture device) and a microphone 122 (or other sound pick-up device). The camera 121 processes image data of still pictures or video obtained by an image capture device in a video capturing mode or an image capturing mode. The processed image frames may be displayed on a display unit 151 (or other visual output device).

The image frames processed by the camera 121 may be stored in the memory 160 (or other storage medium) or transmitted via the wireless communication unit 110. Two or more cameras 121 may be provided according to the configuration of the mobile terminal.

The microphone 122 may receive sounds (audible data) via a microphone (or the like) in a phone call mode, a recording mode, a voice recognition mode, and the like, and can process such sounds into audio data. The processed audio (voice) data may be converted for output into a format transmittable to a mobile communication base station (or other network entity) via the mobile communication module 112 in case of the phone call mode. The microphone 122 may implement various types of noise canceling (or suppression) algorithms to cancel (or suppress) noise or interference generated in the course of receiving and transmitting audio signals.

The user input unit 130 (or other user input device) may generate input data from commands entered by a user to control various operations of the mobile terminal. The user input unit 130 may include a keypad, a dome switch, a touch pad (e.g., a touch sensitive member that detects changes in resistance, pressure, capacitance, etc. due to being contacted) a jog wheel, a jog switch, and the like.

The sensing unit 140 (or other detection means) detects a current status (or state) of the mobile terminal 100 such as an opened or closed state of the mobile terminal 100, a location of the mobile terminal 100, the presence or absence of user contact with the mobile terminal 100 (i.e., touch inputs), the orientation of the mobile terminal 100, an acceleration or deceleration movement and direction of the mobile terminal 100, etc., and generates commands or signals for controlling the operation of the mobile terminal 100. For example, when the mobile terminal 100 is implemented as a slide type mobile phone, the sensing unit 140 may sense whether the slide phone is opened or closed. In addition, the sensing unit 140 can detect whether or not the power supply unit 190 supplies power or whether or not the interface unit 170 is coupled with an external device. The sensing unit 140 may include a proximity sensor (not shown).

The output unit 150 is configured to provide outputs in a visual, audible, and/or tactile manner (e.g., audio signal, video signal, alarm signal, vibration signal, etc.). The output unit 150 may include the display unit 151, an audio output module 152, an alarm unit 153, a haptic module, and the like.

The display unit 151 may display (output) information processed in the mobile terminal 100. For example, when the mobile terminal 100 is in a phone call mode, the display unit 151 may display a User Interface (UI) or a Graphic User Interface (GUI) associated with a call or other communication (such as text messaging, multimedia file downloading, etc.). When the mobile terminal 100 is in a video call mode or image capturing mode, the display unit 151 may display a captured image and/or received image, a UI or GUI that shows videos or images and functions related thereto, and the like.

The display unit 151 may include at least one of a Liquid Crystal Display (LCD), a Thin Film Transistor-LCD (TFT-LCD), an Organic Light Emitting Diode (OLED) display, a flexible display, a three-dimensional (3D) display, or the like.

Some of them may be configured to be transparent or light-transmissive to allow viewing of the exterior, which may be called transparent displays. A typical transparent display may be, for example, a TOLED (Transparent Organic Light Emitting Diode) display, or the like. Through such configuration, the user can view an object positioned at the rear side of the terminal body through the region occupied by the display unit 151 of the terminal body.

The mobile terminal 100 may include two or more display units (or other display means) according to its particular desired embodiment. For example, a plurality of display units may be separately or integrally disposed on one surface of the mobile terminal, or may be separately disposed on mutually different surfaces.

Meanwhile, when the display unit 151 and a sensor (referred to as a ‘touch sensor’, hereinafter) for detecting a touch operation are overlaid in a layered manner to form a touch screen, the display unit 151 may function as both an input device and an output device. The touch sensor may have a form of a touch film, a touch sheet, a touch pad, and the like.

The touch sensor may be configured to convert pressure applied to a particular portion of the display unit 151 or a change in the capacitance or the like generated at a particular portion of the display unit 151 into an electrical input signal. The touch sensor may be configured to detect the pressure when a touch is applied, as well as the touched position and area.

When there is a touch input with respect to the touch sensor, a corresponding signal (signals) are transmitted to a touch controller. The touch controller processes the signals and transmits corresponding data to the controller 180. Accordingly, the controller 180 may recognize which portion of the display unit 151 has been touched.

With reference to FIG. 2, a proximity sensor (not shown) may be disposed within or near the touch screen. The proximity sensor is a sensor for detecting the presence or absence of an object relative to a certain detection surface or an object that exists nearby by using the force of electromagnetism or infrared rays without a physical contact.

Thus, the proximity sensor has a considerably longer life span compared with a contact type sensor, and it can be utilized for various purposes. Examples of the proximity sensor may include a transmission type photoelectric sensor, a direct reflection type photoelectric sensor, a mirror-reflection type photo sensor, an RF oscillation type proximity sensor, a capacitance type proximity sensor, a magnetic proximity sensor, an infrared proximity sensor, and the like. In case where the touch screen is the capacitance type, proximity of the pointer is detected by a change in electric field according to the proximity of the pointer. In this case, the touch screen (touch sensor) may be classified as a proximity sensor.

In the following description, for the sake of brevity, recognition of the pointer positioned to be close to the touch screen will be called a ‘proximity touch’, while recognition of actual contacting of the pointer on the touch screen will be called a ‘contact touch’. In this case, when the pointer is in the state of the proximity touch, it means that the pointer is positioned to correspond vertically to the touch screen.

By employing the proximity sensor, a proximity touch and a proximity touch pattern (e.g., a proximity touch distance, a proximity touch speed, a proximity touch time, a proximity touch position, a proximity touch movement state, or the like) can be detected, and information corresponding to the detected proximity touch operation and the proximity touch pattern can be outputted to the touch screen.

The audio output module 152 may convert and output as sound audio data received from the wireless communication unit 110 or stored in the memory 160 in a call signal reception mode, a call mode, a record mode, a voice recognition mode, a broadcast reception mode, and the like. Also, the audio output module 152 may provide audible outputs related to a particular function performed by the mobile terminal 100 (e.g., a call signal reception sound, a message reception sound, etc.). The audio output module 152 may include a speaker, a buzzer, or other sound generating device.

The alarm unit 153 (or other type of user notification means) may provide outputs to inform about the occurrence of an event of the mobile terminal 100. Typical events may include call reception, message reception, key signal inputs, a touch input etc. In addition to audio or video outputs, the alarm unit 153 may provide outputs in a different manner to inform about the occurrence of an event. For example, the alarm unit 153 may provide an output in the form of vibrations (or other tactile or sensible outputs). When a call, a message, or some other incoming communication is received, the alarm unit 153 may provide tactile outputs (i.e., vibrations) to inform the user thereof. By providing such tactile outputs, the user can recognize the occurrence of various events even if his mobile phone is in the user's pocket. Outputs informing about the occurrence of an event may be also provided via the display unit 151 or the audio output module 152. The display unit 151 and the audio output module 152 may be classified as a part of the alarm unit 153.

A haptic module 154 generates various tactile effects the user may feel. A typical example of the tactile effects generated by the haptic module 154 is vibration. The strength and pattern of the haptic module 154 can be controlled. For example, different vibrations may be combined to be outputted or sequentially outputted.

Besides vibration, the haptic module 154 may generate various other tactile effects such as an effect by stimulation such as a pin arrangement vertically moving with respect to a contact skin, a spray force or suction force of air through a jet orifice or a suction opening, a contact on the skin, a contact of an electrode, electrostatic force, etc., an effect by reproducing the sense of cold and warmth using an element that can absorb or generate heat.

The haptic module 154 may be implemented to allow the user to feel a tactile effect through a muscle sensation such as fingers or arm of the user, as well as transferring the tactile effect through a direct contact. Two or more haptic modules 154 may be provided according to the configuration of the mobile terminal 100.

The memory 160 may store software programs used for the processing and controlling operations performed by the controller 180, or may temporarily store data (e.g., a phonebook, messages, still images, video, etc.) that are inputted or outputted. In addition, the memory 160 may store data regarding various patterns of vibrations and audio signals outputted when a touch is inputted to the touch screen.

The memory 160 may include at least one type of storage medium including a flash memory, a hard disk, a multimedia card micro type, a card-type memory (e.g., SD or DX memory, etc), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, and an optical disk. Also, the mobile terminal 100 may be operated in relation to a web storage device that performs the storage function of the memory 160 over the Internet.

The interface unit 170 serves as an interface with every external device connected with the mobile terminal 100. For example, the external devices may transmit data to an external device, receives and transmits power to each element of the mobile terminal 100, or transmits internal data of the mobile terminal 100 to an external device. For example, the interface unit 170 may include wired or wireless headset ports, external power supply ports, wired or wireless data ports, memory card ports, ports for connecting a device having an identification module, audio input/output (I/O) ports, video I/O ports, earphone ports, or the like. The identification module may be a chip that stores various information for authenticating the authority of using the mobile terminal 100 and may include a user identity module (UIM), a subscriber identity module (SIM) a universal subscriber identity module (USIM), and the like. In addition, the device having the identification module (referred to as ‘identifying device’, hereinafter) may take the form of a smart card. Accordingly, the identifying device may be connected with the terminal 100 via a port.

When the mobile terminal 100 is connected with an external cradle, the interface unit 170 may serve as a passage to allow power from the cradle to be supplied therethrough to the mobile terminal 100 or may serve as a passage to allow various command signals inputted by the user from the cradle to be transferred to the mobile terminal therethrough. Various command signals or power inputted from the cradle may operate as signals for recognizing that the mobile terminal is properly mounted on the cradle.

The controller 180 typically controls the general operations of the mobile terminal. For example, the controller 180 performs controlling and processing associated with voice calls, data communications, video calls, and the like. The controller 180 may include a multimedia module 181 for reproducing multimedia data. The multimedia module 181 may be configured within the controller 180 or may be configured to be separated from the controller 180.

The controller 180 may perform a pattern recognition processing to recognize a handwriting input or a picture drawing input performed on the touch screen as characters or images, respectively.

The power supply unit 190 receives external power or internal power and supplies appropriate power required for operating respective elements and components under the control of the controller 180.

Various embodiments described herein may be implemented in a computer-readable or its similar medium using, for example, software, hardware, or any combination thereof.

For hardware implementation, the embodiments described herein may be implemented by using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic units designed to perform the functions described herein. In some cases, such embodiments may be implemented by the controller 180 itself.

For software implementation, the embodiments such as procedures or functions described herein may be implemented by separate software modules. Each software module may perform one or more functions or operations described herein. Software codes can be implemented by a software application written in any suitable programming language. The software codes may be stored in the memory 160 and executed by the controller 180.

### Function of Updating Phone Book

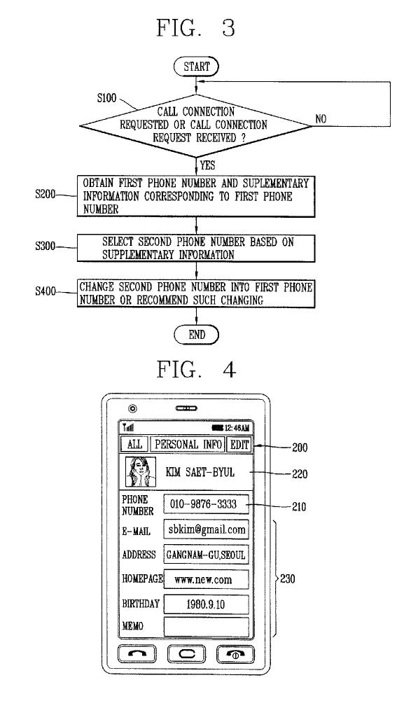

FIG. 3 is a flow chart illustrating the process of updating a phone book according to an exemplary embodiment of the present invention.

The wireless communication unit 110 monitors whether or not a call connection is requested or a request for a call connection is received (step S100). When a call connection is requested or a request for a call connection is received, the wireless communication unit 110 obtains a changed phone number (a first phone number) of a counterpart and supplementary information corresponding to the first phone number (step S200). The first phone number and the supplementary information corresponding to the first phone number may be obtained from a message or a conversation transmitted or received according to a call connection.

The controller 180 may select a phone number (a second phone number) presumed to be an old phone number (namely, a phone number before being changed) of the counterpart from a phone book (step S300). The controller 180 may search the phone book for the supplementary information obtained by the wireless communication unit 110 and select a phone number corresponding to the supplementary information.

The controller 180 may change the second phone number selected from the phone book into the first phone number or may recommend changing of the second phone number into the first phone number (step S400). For example, the controller 180 may change the second phone number into the first phone number and store it in the phone book. Or, when a plurality of second phone numbers are selected, the controller 180 may provide information regarding the plurality of second phone numbers to the user, change one or more second phone numbers selected by the user from among the plurality of second phone numbers into the first phone number, and store the same in the phone book. Or, the controller 180 may provide information regarding the second phone number to the user, change the second phone number into the first phone number according to a user instruction, and store the same in the phone book.

Also, the controller 180 may change the selected second phone number into the first phone number, or recommend such changing, before, during, or after a communication session according to a call connection. For example, the controller 180 may change the selected second phone number into the first phone number or recommend such changing, before a call is connected, during a call communication, or after a call connection is terminated.

### Updating of Phone Book According to Supplementary Information

FIG. 4 is an overview of a display screen illustrating a phone book stored in a phone book and supplementary information according to an exemplary embodiment of the present invention.

The phone book according to an exemplary embodiment of the present invention may refer to a database storing phone numbers of acquaintances of the user of the mobile terminal 100. For example, the phone book may be stored in the memory 160, or in an identification module storing various types of information for authenticating the authority of using the mobile terminal 100, such as USIM, or the like. Also, supplementary information, such as the names of acquaintances, along with the phone numbers of the acquaintances may be stored in the phone book.

In general, the mobile terminal 100 may provide a function of managing the information stored in the phone book. For example, when one of phone numbers on a phone number list stored in the phone book is selected, a screen image 200 including the selected phone number 210 and supplementary information 220 and 230 corresponding to the selected phone number 210 may be displayed. The supplementary information 220 and 230 corresponding to the phone number 210 may include the name 220, an e-mail address, an address (home or office), a homepage address, the birthday, memo 230 of an acquaintance, and the like. Also, the supplementary information 220 and 230 corresponding to the selected phone number 210 may further include an image for recognizing the acquaintance, such as an image of the acquaintance, or the like.

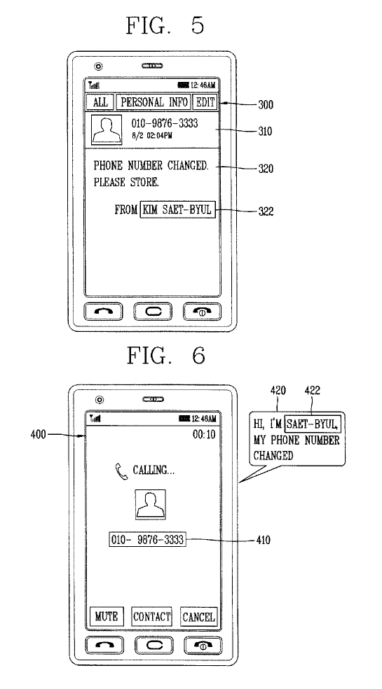

FIG. 5 is an overview of a display screen illustrating the process of updating a phone book according to a first exemplary embodiment of the present invention.

In an exemplary embodiment of the present invention, a call connection may include a message call connection, and the message call connection may be a message call connection according to a text message service, an instant message service, or an e-mail service. The text message service refers to a service allowing terminals to exchange a brief message through a network, and the instant message service refers to a service allowing two or more users to perform real time communication based on text. The e-mail service refers to a service allowing users to exchange a digital message through the Internet or any other network.

Meanwhile, the message service may include a short message service (SMS), a multimedia messaging service (MMS), and an enhanced messaging service (EMS). The SMS refers to a text-based communication service of a mobile terminal, a Web, or a mobile communication system. The MMS refers to a transmission and reception service of a message including multimedia contents in a mobile terminal. The EMS, a medium technique between the SMS and the MMS, refers to a service for allowing mobile terminal to transmit and receive a message including a special text format (e.g., bold, italic), animation, a picture, an icon, a sound effect, and a special bell sound.

A message transmitted and received through the text message service may include a header part including a source phone number (a transmission number) and a destination phone number (a reception number), and a body part including content of the message. Alternatively, the transmission number or the reception number may be included in the body part according to an implementation. Also, a message transmitted or received through the instant message service or the e-mail service may include a header part including source and destination addresses (an IP address or an e-mail address) and a body part including content of the message (including a transmission number or a reception number).

When the mobile terminal 100 requests a message call connection or receives a request for a message call connection, it may determine whether or not a transmission number or a reception number (a changed phone number or a new phone number of the counterpart) is a phone number stored in the phone book. When the changed phone number of the counterpart is not stored in the phone book, the mobile terminal 100 may construe (or parse) content of the message to obtain supplementary information corresponding to the phone number of the counterpart and select a phone number presumed to be the old phone number of the counterpart from among the phone numbers stored in the phone book based on the obtained supplementary information.

For example, the mobile terminal 100 may parse meaningful words of the message content by token (i.e., a unit string discriminated by blank character, a symbol, and the like) and obtain the supplementary information corresponding to the changed phone number of the counterpart or obtain the changed phone number of the counterpart and the corresponding supplementary information to select a phone number presumed to be the old phone number of the counterpart from the phone book. Also, the terminal 100 may obtain the supplementary information corresponding to the changed phone number of the counterpart, or the changed phone number of the counterpart and the corresponding supplementary information, from an image included in the message by using an optical character recognition (OCR) technique. Also, the terminal 100 may obtain the supplementary information corresponding to the changed phone number of the counterpart, or the changed phone number of the counterpart and the corresponding supplementary information, from a voice included in the message by using a speech-to-text (STT) technique.

With reference to FIG. 5, a screen 300 displaying a text message received from the counterpart includes an area 310 including reception information and an area 320 including content of the text message. The area 310 including the reception information may include the changed phone number of the counterpart and a reception time. The area 320 including content of the text message may include supplementary information 322 corresponding to the changed phone number of the counterpart. The controller 180 parses the content of the text message to obtain the supplementary information 322 corresponding to the changed phone number of the counterpart, search the phone book for the obtained supplementary information, and select a phone number presumed to be the old phone number of the counterpart. The controller 180 may change the selected phone number into the changed phone number or recommend such changing.

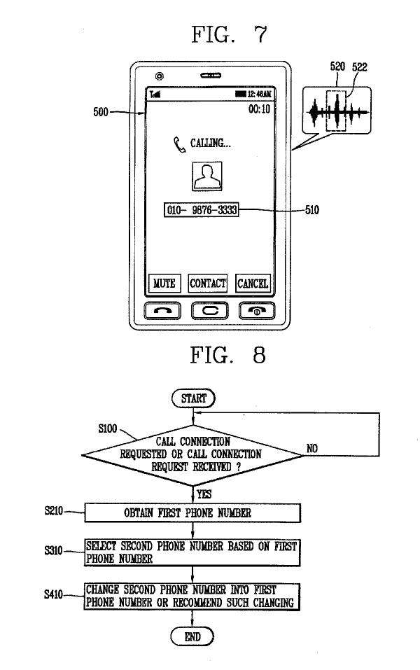

FIGS. 6 and 7 are overviews of display screens illustrating the process of updating a phone book according to a second exemplary embodiment of the present invention.

In an exemplary embodiment of the present invention, a call connection may include a communication call connection, and the call may be a voice call or a video call. In this case, the communication call includes the changed phone number (or the new phone number) of the counterpart and a voice signal (or a voice and image signal) of the counterpart. When the mobile terminal 100 requests a communication call connection or receives a request for a communication call connection, the mobile terminal 100 may determine whether or not the changed phone number of the counterpart included in the communication call is a phone number stored in the phone book. When the changed phone number of the counterpart is not stored in the phone book, the mobile terminal 100 may construe (or parse) content of a conversation and select a phone number presumed to be the old phone number of the counterpart.

In detail, the mobile terminal 100 compares the supplementary information corresponding to the changed phone number of the counterpart obtained by demodulating, decoding and parsing the voice signal included in the communication call with the supplementary information stored in the phone book, and selects a phone number presumed to be the old phone number of the counterpart. In this case, the STT technique may be used. Or the mobile terminal 100 compares a voice pattern of the counterpart obtained by demodulating and decoding a voice signal included in the communication call with a voice pattern stored in the phone book or the memory 160 and selects a phone number presumed to be the old phone number of the counterpart. In this case, the voice pattern stored in the phone book or the memory 160 may be a voice pattern input through the microphone 122 of the mobile terminal or a voice pattern which has been extracted from content of a conversation and stored.

With reference to FIG. 6, a screen 400 in the course of conversation with the counterpart may include a changed phone number (or a new phone number) 410 of the counterpart. The controller 180 may convert a voice signal into content 420 of a conversation in a text format by using the STT. Also, the controller 180 may parse the call content 420 to obtain supplementary information 422 corresponding to the changed phone number of the counterpart, search the phone book for the obtained supplementary information 422 to select a phone number presumed to be the old phone number of the counterpart. The controller 180 changes the selected phone number presumed to be the old phone number of the counterpart into the changed phone number 410 or recommend such changing.

With reference to FIG. 7, a screen 500 in the course of conversation with the counterpart may include a changed phone number (or a new phone number) 510. The controller 180 may analyze a voice pattern 522 of the counterpart in content 520 of a conversation, search the phone book or the memory 160 for the voice pattern 522 of the counterpart, and select a phone number presumed to be an old phone number of the counterpart. In this case, the voice pattern may include the pitch, strength, tone, and other pronunciation characteristics (speed, tempo, intonation, accent, and the like) of a sound extracted from the voice signal. The mobile terminal 100 selects a phone number presumed to be the old phone number of the counterpart based on a voice pattern identical within a certain range to the pitch of the sound, strength of the sound, tone of the sound, and other pronunciation characteristics of the sound extracted from the voice signal among voice patterns stored in the phone book or the memory 160. The controller 180 may change the selected phone number into the changed phone number 510 of the counterpart or recommend such changing.

### Updating of Phone Book According to Phone Number of Counterpart

FIG. 8 is a flow chart illustrating the process of updating a phone book according to another exemplary embodiment of the present invention.

The wireless communication unit 110 monitors whether or not a call connection is requested or a request for a call connection is received (step S100). When a call connection is requested or a request for a call connection is received in step S100, the wireless communication unit 110 obtains a changed phone number (a first phone number) of a counterpart (step S210). The first phone number may be obtained from a call connection which has been requested or received.

The controller 180 may select a phone number (a second phone number) presumed to be an old phone number (namely, a phone number before being changed) of the counterpart from a phone book (step S310). The controller 180 may search the phone book for the second phone number based on the first phone number obtained by the wireless communication unit 110 from a message or a conversation and select the searched second phone number.

The controller 180 may change the second phone number selected from the phone book into the first phone number or may recommend changing of the second phone number into the first phone number (step S410). For example, the controller 180 may change the second phone number into the first phone number and store it in the phone book. Or, when a plurality of second phone numbers are selected, the controller 180 may provide information regarding the plurality of second phone numbers to the user, change the second phone number selected by the user from among the plurality of second phone numbers into the first phone number, and store the same in the phone book. Or, the controller 180 may provide information regarding the second phone number to the user, change the second phone number into the first phone number according to a user instruction, and store the same in the phone book.

Also, the controller 180 may change the selected second phone number into the first phone number, or recommend such changing, before, during, or after a communication session according to a call connection. For example, the controller 180 may change the selected second phone number into the first phone number or recommend such changing, before a call is connected, during a call communication, or after a call connection is terminated.

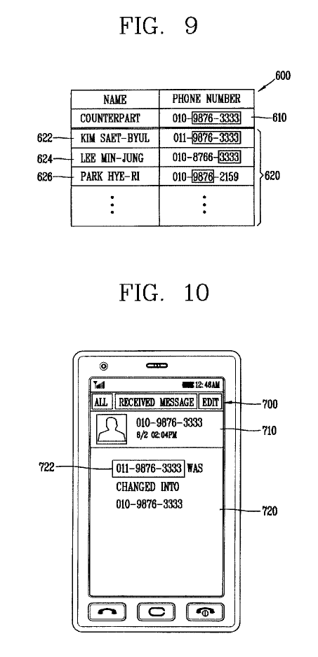

FIG. 9 is an overview of a display screen illustrating the process of updating a phone book according to a third exemplary embodiment of the present invention.

The phone number includes an international number or a domestic number, and the international number includes a country code and a domestic number. The domestic number includes a communication network number, an area code, and a subscriber number. The subscriber number includes a local number of 1 to 4 digits and 4-digit individual subscriber number. The network number refers to a number assigned to a service provider, including X (an integer from 1 to 9), Y (an integer from 0 to 9), and the like. The subscriber number is used within a network to which the subscriber is directly connected, which includes a local number and a individual subscriber number.

Meanwhile, in general, when the user changes his mobile terminal in use, he may use the original phone number as it is, or a situation may occur in which the phone number may be changed according to mobile number portability (MNP)from 2g to 3g or personal circumstances. Also, although the user uses his mobile terminal as it is, only the phone number may be changed. In this case, only the network number of the original phone number may be changed or the network number and only a first digit of the local number may be changed according to the mobile number portability from 2g to 3g. Or, although the phone number is changed, the individual subscriber number may be maintained as it is according to personal circumstances. The mobile terminal 100 according to an exemplary embodiment of the present invention may compare the phone number stored in the phone book and the changed phone number of the counterpart not stored in the phone book, select a phone number presumed to be the old phone number of the counterpart, change the selected phone number into the changed phone number of the counterpart, and store the changed phone number in the phone book or recommend changing the phone number and storing it in the phone book.

The controller 180 may select a phone number similar to the changed phone number of the counterpart from among the phone numbers stored in the phone book, and change the selected phone number into the changed phone number of the counterpart or recommend such changing. For example, the controller 180 may select a phone number similar to the changed phone number of the counterpart from the phone book through comparison of the network number, the area code, and the subscriber number. Or, the controller 180 may select a phone number including a portion of the changed phone number of the counterpart from among the phone numbers stored in the phone book.

With reference to FIG. 9, a phone number comparison table 600 includes phone numbers 620 similar to the phone number 610 of the counterpart among the phone numbers stored in the phone book. In an exemplary embodiment, the controller 180 determines similarity in order of a case in which the local number and the individual subscriber number of the phone number of the counterpart are identical to those of the phone number stored in the phone book, a case in which only the individual subscriber number is identical, and a case in which only the local number is identical. Because the local number and the individual subscriber number of the phone number 622 are identical to those of the phone number 610 of the counterpart, the controller 180 determines that the phone number 622 has the highest similarity. Or, because the local number of a phone number 624 is different from that of a phone number 626 of a counterpart but the individual subscriber number of the phone number 624 is identical to that of the phone number 626 of the counterpart, the controller 180 determines that the phone number 624 has the second highest similarity. Also, because the subscriber individual number of the phone number 626 is different but the local number of the phone number 626 is identical to that of the phone number 626 of the counterpart, the controller 180 determines that the phone number 626 has the third highest similarity. Besides, the controller 180 may determine the similarity in order of a case in which a portion of the individual subscriber number is identical to the phone number of the counter part or a case in which a portion of the local number is identical to the phone number of the counter part.

The controller 180 may select the phone number 622 determined to be the most similar to the changed phone number of the counterpart. Or, the controller 180 may provide information regarding the phone numbers 620 determined to be similar to the changed phone number of the counterpart to the user, and select one or more phone numbers selected by the user from among the provided phone numbers. Or, the controller 180 may provide information regarding the phone number 622 determined to be the most similar to the changed phone number of the counterpart to the user, and select the phone number 622 based on a confirmation instruction of the user.

The controller 180 may display the phone numbers stored in the phone book in order, starting from one having the highest similarity to the changed phone number of the counterpart through the display unit 151. In this case, the controller 180 may display only some, of the phone numbers stored in the phone book, having a high similarity according to a configuration. Also, the controller 180 may directly change the phone number having the highest similarity, among the phone numbers stored in the phone book, into the phone number of the counterpart and store the same, rather than displaying the phone numbers stored in the phone book in the order of the similarity starting from one having the highest similarity, according to a configuration.

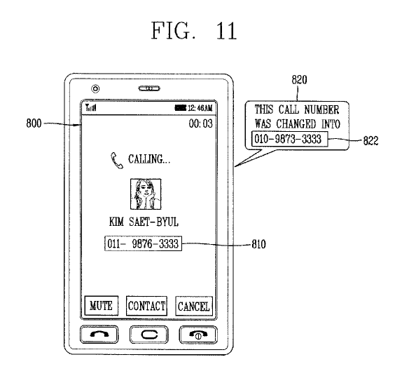

FIG. 10 is an overview of a display screen illustrating the process of updating a phone book according to a fourth exemplary embodiment of the present invention.

With reference to FIG. 10, a screen 700 displaying a text message received from the counterpart may include an area 710 including reception information and an area 720 including content of the text message. The area 710 including the reception information includes a changed phone number of the counterpart and a reception time. The area 720 including the content of the text message includes a phone number 722 presumed to be an old phone number of the counterpart. The controller 180 parses the content of the text message to obtain the phone number 722, and search the phone book for the obtained phone number 722 to select the searched phone number. Also, the controller 180 may change the selected phone number into the changed phone number or recommend such changing. In an exemplary embodiment of the present invention, the received text message may be a text message provided by a new phone number notification service.

FIG. 11 is an overview of a display screen illustrating the process of updating a phone book according to a fifth exemplary embodiment of the present invention.

With reference to FIG. 11, a screen 800 in the course of conversation with the counterpart includes an old phone number 810 of the counterpart. The controller 180 converts a voice signal into content 820 of a conversation by using the STT, or the like. Also, the controller 180 parses the content 820 of a conversation to obtain a changed phone number 822 of the counterpart, and searches the phone book for the phone number 810 presumed to be the old phone number of the counterpart, and selects the searched phone number. Also, the controller 180 changes the selected phone number into the new phone number 822 of the counterpart or recommend such changing.

According to an exemplary embodiment of the present invention, the phone book is updated based on the context information collected in the process of communication with the counterpart whose phone number has been changed in the mobile terminal. Thus, the user can conveniently store the changed phone number of the counterpart, and at the counterpart side inconvenience of informing the acquaintances about the changed phone number of the counterpart one by one as changed can be reduced.

The mobile terminal according to an exemplary embodiment of the present invention may be any terminal that can transmit and receive a text message, such as a smart phone, a notebook computer, a laptop computer, a digital broadcast terminal, a personal digital assistant (PDA), a portable multimedia player, a navigation device, as well as a mobile phone. The configurations and methods according to the foregoing exemplary embodiments are not limitedly applied, and the entirety or portions of the exemplary embodiments may be selectively combined to be modified variably.

First, terms or words used in the present specification and the claims should not be construed as being limited to general or literal meaning, but should be construed in meaning and concept that coincide with the technical spirit of the invention. Thus, configurations shown in embodiments and the drawings of the present invention rather is an example of the most exemplary embodiment and does not represent all of the technical spirit of the invention. Thus, it will be understood that various equivalents and modifications that replace the configurations are possible when filing the present application.

1. A mobile terminal comprising:
a communication unit configured to obtain a first phone number and supplementary information corresponding to the first phone number when a call connection is requested or a call connection request is received; and
a controller configured to select a second phone number stored in a phone book based on the supplementary information, and change the selected second phone number into the first phone number or recommend changing of the selected second phone number into the first phone number.

2. The mobile terminal of claim 1, wherein the call connection is a communication call connection or a message call connection.

3. The mobile terminal of claim 2, wherein the message call connection is a message call connection according to a text message service, an instant message service, or an e-mail service.

4. The mobile terminal of claim 3, wherein the text message service is a short message service (SMS), a multimedia messaging service (MMS), or an enhanced message service (EMS).

5. The mobile terminal of claim 1, wherein the supplementary information corresponding to the first phone number is obtained from a message or a conversation transmitted or received according to the call connection.

6. The mobile terminal of claim 1, wherein the supplementary information corresponding to the first phone number comprises at least one of a name, an address, an e-mail address, a homepage address, an image, and a birthday.

7. The mobile terminal of claim 1, wherein the supplementary information corresponding to the first phone number comprises a voice pattern.

8. The mobile terminal of claim 1, wherein the supplementary information corresponding to the first phone number is obtained by using speech-to-text.

9. The mobile terminal of claim 1, wherein the controller changes the selected second phone number into the first phone number or recommends changing of the selected second phone number into the first phone number, before, during, or after a communication session according to the call connection.

10. A method for updating a phone book of a mobile terminal, the method comprising:
when a call connection is requested or when a call connection request is received, obtaining a first phone number and supplementary information corresponding to the first phone number;
selecting a second phone number stored in a phone book based on the supplementary information; and
changing the selected second phone number into the first phone number or recommending changing of the selected second phone number into the first phone number.

11. A mobile terminal comprising:
a communication unit configured to obtain a first phone number when a call connection is requested or a call connection request is received; and
a controller configured to select a second phone number stored in a phone book based on the first phone number, and change the selected second phone number into the first phone number or recommend changing of the selected second phone number into the first phone number.

12. The mobile terminal of claim 11, wherein the call connection is a communication call connection or a message call connection.

13. The mobile terminal of claim 11, wherein the first phone number is obtained from a message or a conversation transmitted or received according to the call connection.

14. The mobile terminal of claim 11, wherein the first phone number is obtained by using speech-to-text.

15. The mobile terminal of claim 11, wherein the controller changes the selected second phone number into the first phone number or recommends changing of the selected second phone number into the first phone number, before, during, or after a communication session according to the call connection.
